(19) United States
(12) Patent Application Publication
(10) Pub. No.: US 2026/0127307 A1
(43) Pub. Date: May 7, 2026

(54) FINE-GRAIN CONTROL SYSTEM USING PERMISSION RULES GENERATED BY A LANGUAGE MODEL

(71) Applicant: Lenovo Global Technology (United States) Inc., Morrisville, NC (US)

(72) Inventors: Christian De Hoyos, Oceanside, CA (US); Igor Stolbikov, Apex, NC (US); Scott Li, Cary, NC (US); Rod D Waltermann, Rougemont, NC (US)

(21) Appl. No.: 18/939,704

(22) Filed: Nov. 7, 2024

(51) Int. Cl. G06F 21/62

(52) U.S. Cl. CPC G06F 21/6218

(57) ABSTRACT

A system management application includes program instructions for monitoring performance of a process running on a compute node of a computing system and providing a plurality of permission rules to be implemented by a fine-grain control system running on the compute node. Each permission rule instructs the fine-grain control system to permit or deny the process with access to specific resources. Access error data is received from the compute node identifying an access error indicating that the process was denied access to a specific resource by the fine-grain control system. The access error data is provided to an artificial intelligence model that has been trained to generate permission rules and an update of the permission rules is generated, wherein the update permits the process to access the specific resource. The update is then provided to the fine-grain control system.

### BACKGROUND

The present disclosure relates to the use of fine-grain control systems to improve security in a computing system.

### BACKGROUND OF THE RELATED ART

Many complex, multi-component systems need to run multiple software components in a computing system, but managing security for these multiple software components is a challenge. It is generally ineffective to simply rely upon network security to keep everything within the network secure.

Fine-grain control systems provide security that is separately configurable at the asset level, meaning that the permission rules implemented on each asset (i.e., software and hardware component or product) can be customized or specific to that asset. Fine-grain control systems like Security-Enhanced Linux (SELinux), AppArmor or Java security managers provide a robust framework for access control and mandatory access controls (MAC) on Linux systems. For example, SELinux is a Linux kernel security module. The kernel is at the core of an operating system and has control over conflicts between processes and interactions between software and hardware components.

SELinux was developed by the National Security Agency (NSA) in collaboration with the open-source community to implement a fine-grained permissions model. Unlike traditional discretionary access controls (DAC), which rely on user and group ownership, SELinux allows administrators to define and enforce policies that specify the actions and processes that users can perform on resources. SELinux policy is a set of permission rules that defines which processes (i.e., an instance of a computer program being executed) can access which files, directories (folders), and ports (i.e., TCP or UDP ports). The permission rules identify processes and define whether the identified processes are permitted to access certain files and other processes. If a particular action that a process wants to perform is not explicitly permitted in the installed policy, SELinux will deny it. With the permission rules established, the fine-grain control system will only permit an application or process to access certain files (perhaps identified by filename and/or file type) and other processes that the process requires to function. However, a fine-grain control system may have to support and maintain hundreds of fine-grain permission rules to specifically identify all of the different processes and the files and other processes that each process may access.

The importance of SELinux lies in its ability to mitigate the impact of security vulnerabilities and limit the damage caused by malicious activities. By enforcing a strict set of rules, SELinux and similar fine-grain control systems prevent unauthorized access to components in a computing system and reduce the attack surface of the computing system, enhancing the overall security posture. SELinux (or another fine-grain control system) can play an important role in safeguarding sensitive data, protecting against privilege escalation, and maintaining the integrity of the computing system.

### BRIEF SUMMARY

Some embodiments provide a computer program product comprising a non-transitory computer readable storage medium and program instructions embodied therein, the program instructions being configured to be executable by a processor to cause the processor to perform various operations. The operations comprise monitoring performance of a process running on a compute node of a computing system and providing a plurality of permission rules to be implemented by a fine-grain control system running on the compute node, wherein, for each of the permission rules, the permission rule instructs the fine-grain control system to permit or deny the process with access to one or more resources identified by the permission rule. The operations further comprise receiving access error data from the compute node that identifies an access error experienced by the process, wherein the access error indicates that the process attempted to access a specific resource and was denied access to the specific resource by the fine-grain control system. Still further, the operations comprise providing the access error data to an artificial intelligence model that has been trained to generate permission rules for processes and receiving an update of the permission rules from the artificial intelligence model, wherein the update of the permission rules permits the process to access the specific resource indicated by the access error. In addition, the operations further comprise providing the update of the permission rules to the fine-grain control system running in the computing system.

Some embodiments provide a method comprising various operations. The operations comprise monitoring performance of a process running on a compute node of a computing system and providing a plurality of permission rules to be implemented by a fine-grain control system running on the compute node, wherein, for each of the permission rules, the permission rule instructs the fine-grain control system to permit or deny the process with access to one or more resources identified by the permission rule. The operations further comprise receiving access error data from the compute node that identifies an access error experienced by the process, wherein the access error indicates that the process attempted to access a specific resource and was denied access to the specific resource by the fine-grain control system. Still further, the operations comprise providing the access error data to an artificial intelligence model that has been trained to generate permission rules for processes and receiving an update of the permission rules from the artificial intelligence model, wherein the update of the permission rules permits the process to access the specific resource indicated by the access error. In addition, the operations further comprise providing the update of the permission rules to the fine-grain control system running in the computing system.

### BRIEF DESCRIPTION OF THE SEVERAL VIEWS OF THE DRAWINGS

FIG. 1 is a diagram of a computing system implementing fine-grain control for processes running on compute nodes within the computing system according to one embodiment.

FIG. 2 is a diagram of a computer that may be used to perform a computer program product according to one embodiment.

FIG. 3 is a flowchart of operations according to one embodiment.

### DETAILED DESCRIPTION

Some embodiments provide a computer program product comprising a non-transitory computer readable storage medium and program instructions embodied therein, the program instructions being configured to be executable by a processor to cause the processor to perform various operations. The operations comprise monitoring performance of a process running on a compute node of a computing system and providing a plurality of permission rules to be implemented by a fine-grain control system running on the compute node, wherein, for each of the permission rules, the permission rule instructs the fine-grain control system to permit or deny the process with access to one or more resources identified by the permission rule. The operations further comprise receiving access error data from the compute node that identifies an access error experienced by the process, wherein the access error indicates that the process attempted to access a specific resource and was denied access to the specific resource by the fine-grain control system. Still further, the operations comprise providing the access error data to an artificial intelligence model that has been trained to generate permission rules for processes and receiving an update of the permission rules from the artificial intelligence model, wherein the update of the permission rules permits the process to access the specific resource indicated by the access error. In addition, the operations further comprise providing the update of the permission rules to the fine-grain control system running in the computing system.

In some embodiments, the computer program product may be installed on a system management server and/or may be included in a system management application. The system management application may monitor and control various aspects of the computing system, such as the performance and security of various processes running on the computing system. Optionally, the artificial intelligence model may be run on the same management server or other compute node where the system management application including the computer program product is being run. Alternatively, any one or more of the computer program products, the system management application and/or the artificial intelligence model may be run on a separate compute node or in a cloud computing environment.

The term “process” refers to any instance of a computer program or application that is currently being executed by one or more processors. While the computer program product comprising program instructions may be stored on a non-transitory computer readable storage medium, such as a hard disk drive or solid state drive, a corresponding process is the execution of those program instructions after being loaded from the computer readable storage medium into memory. Accordingly, a given computer program or application may be executed as multiple process instances. Furthermore, a given computing system or compute node within the computing system may host any number of processes, where each process may be an instance of the same computer program or application or may be an instance of a different computer program or application. While the operations of the computer program product of various embodiments may be described in reference to “a process”, it should be appreciated that the same operations may be performed as to any number of processes, either simultaneously, sequentially or without regarding to any particular timing.

The term “compute node” refers to a unit of hardware that can perform (i.e., execute) program instructions. Large computing systems may include many compute nodes that are able to communicate over one or more network. In one non-limiting example, a plurality of compute nodes may reside within a local area network and a system management application may communicate with the processes running on the plurality of compute nodes over a wide area network. The compute nodes may have any of a wide variety of form factors and configurations, such as a rack server or blade server. However, each compute node will have a processing unit including at least one processor for executing program instructions and memory for storing the program instructions during execution.

The term “fine-grain control system” refers to a software system that implements access control to and/or from resources, such as a file, folder, process and/or logical port, with a high level of granularity. The precise manner of access control is implemented by permission rules, which may include one or more specific permission rules for each resource or resource type. Accordingly, a permission rule for a given resource or resource type may identify and control which other resources or resource types that the given resource or resource type is permitted to access, and which other resources or resource types are permitted to access the given resource or resource type. In one option, a permission rule may identify a particular environment context, a regulatory requirement, technical limitations such as server space or computation space, and an internal governance requirement. Non-limiting examples of available fine-grain control systems include SELinux, AppArmor and Java security manager. Manually setting up a fine-grained access control system requires a deep understanding of the normal operational requirements of various processes and resources and security policies to be implemented. Fine-grain control systems may also require a high level of upfront and ongoing effort to manage and respond to changes in the system and processes. Any misconfiguration of the fine-grain control system may lead to unintended consequences, such as a process receiving a denial of service or failing to run correctly.

It is a technical benefit of the embodiments that a fine-grain control system may be fully implemented with less effort, fewer process failures, and faster response to access errors and threats to increase performance and security. Accordingly, embodiments may simplify implementation of the most secure configuration of a fine-grain control system that is possible while still allowing known processes and resources to operate fully, with the least human involvement. Furthermore, embodiments of the intelligent fine-grain control system may yield improved security and operability on clusters with Linux devices and servers that are currently misconfigured or under-configured. In a system with multiple and/or different fine-grain control systems, embodiments may provide the technical benefit of providing permission rules that implement consistent policies, work collectively and are managed efficiently.

In some embodiments, the artificial intelligence model may dynamically update the permission rules during operation of the process on the computing system running the fine-grain control system. As used herein, “dynamic” generation of permission rules means that the permission rules are continuously updated, periodically updated, and/or updated in response to some event. For example, as a process is being executed by a processor of a compute node, the process may experience an access error. The system management application monitoring the performance of processes on the compute node may detect the access error and report the access error to the artificial intelligence model for the purpose of generating an update of the permission rules. After receiving the update of the permission rules from the artificial intelligence model, the system management application provides the update of the permission rules to the fine-grain control system on the compute node. Accordingly, the fine-grain control system may implement the update of the permission rules to, for example, permit the process to access a resource that was previously restricted.

An update of the permission rules may include any one or more changes to the permissions rules for a process or other resource. For example, an update of the permission rules could include a revision to one or more of the existing permission rules, one or more additional permission rules, and/or a deletion of one or more of the permission rules. A revision to one or more of the existing permission rules may alter an existing permission rule to be either more restrictive or more permissive regarding access to one or more resources.

In some embodiments, access error data and/or threat data may be included in one or more output logs for the compute node. Accordingly, the system management application may monitor each output log, or the compute node may automatically send updates from its one or more output logs to the system management application. The access error data and/or threat data is preferably obtained by the system management application in real-time or at short pre-configured intervals so that the permission rules may be timely updated to address each access error or threat. Timely addressing an access error experienced by a process or other resource may restore or improve performance of the process or resource. Timely addressing a threat may prevent or limit a security breach, a loss of data or a denial of service. In one non-limiting example, the operations of receiving access error data from the compute node, providing the access error data to the artificial intelligence model, receiving an update of the permission rules from the artificial intelligence model, and providing the update of the permission rules to the fine-grain control system running in the computing system are repeated continuously, periodically, and/or in response to some event.

In some embodiments, the operations may further comprise receiving threat data from the compute node that identifies a threat posed against the process by another process attempting to access the process or one of the resources to which the process has access. Still further, the operations may comprise providing the threat data to the artificial intelligence model, receiving a second update of the permission rules from the artificial intelligence model, wherein the second update of the permission rules prevents the threat posed against the process indicated by the threat data, and providing the second update of the permission rules to the fine-grain control system running in the computing system. Accordingly, some updates of the permission rules may address access errors, some updates of the permission rules may address threats, and some updates of the permission rules may address both access errors and threats. The threat data, as well as the access error data, may be received and processed in real-time, continuously, periodically, and/or in response to an event. For example, the artificial intelligence model may receive ongoing input from the computing system regarding threats to security due to the permission rules being too permissive and/or limitations on performance due to the permission rules being too restrictive. An overly restrictive permission rule may negatively impact the ability of an application or service to run or function the way it is intended. The artificial intelligence model may respond to the limitations on performance by providing the fine-grain control system located where the threat or limitation was detected with a new permission rule to enable the process or service to do its job and remediate the threat or limitation.

The permission rules may be configured in any manner to effectively communicate one or more access controls to a fine-grain control system. As one example, a permission rule may be a “restrictive” rule that prevents a resource from accessing one or more specific resources that are expressly identified. Using the restrictive rule type, other resources that are not expressly identified as being restricted may be accessed by the referenced resource. As another example, a permission rule may be a “permissive” rule that allows the process to access only one or more specific resources that are expressly identified. Using the permissive rule type, other resources that are not expressly identified as being accessible to the resource are restricted from access. The permission rules for any one or more of the resources may have any combination of one or more restrictive rules and/or one or more permissive rules. A permission rule may also be configured to address multiple resources that have some common characteristic. For example, all processes of a given process type may be permitted to access files of a specific file type, but restricted from accessing any file that does not have that specific file type.

In some embodiments, the computing system may run a plurality of fine-grain control systems. For example, a separate instance of a fine-grain control system may operate at various levels/layers within the software stack of a single compute node and/or within each of a plurality of compute nodes within the computing system. These fine-grain control systems may be located throughout the computing system and may receive their permission rules and/or dynamic updates to their permission rules from a system management application running on a system management server. In one option, the system management application may be, or include Lenovo XClarity Administrator (LXCA) or Lenovo XClarity Orchestrator (LXCO). The system management application may further include, or have access to, an artificial intelligence (AI) model, such as a language model (LM), that provides permission rules and/or updates to the permission rules to each of the fine-grain control systems in the computing system. In one option, the operation of providing a plurality of permission rules to be implemented by a fine-grain control system running on the compute node may include providing a plurality of permission rules to be implemented by each of the fine-grain control systems. Furthermore, the operation of providing the update of the permission rules to the fine-grain control system running in the computing system may include providing the update of the permission rules to the fine-grain control system running on the compute node where the process that experienced the access error is also running. A non-limiting example of a language model is a large language model (LLM).

In some embodiments, the computing system may run a plurality of fine-grain control systems including at least one fine-grain control system running on each of a plurality of compute nodes within the computing system. In another option, the plurality of fine-grain control systems running in the computing system may include at least one fine-grain control system running on each of a plurality of layers of a software stack running on at least one compute node within the computing system. For example, the layers of the software stack may include some or all of the seven layers of the Open System Interconnection (OSI) model, such as layers from the application layer down to the physical layer. Accordingly, a fine-grain control system may implement permission rules across the multiple layers of the OSI model or a separate fine-grain control system may implement permission rules at one or more of the layers of the OSI model. For example, in the application layer of the OSI model, a fine-grain control system may implement permission rules that control function level access or permissions, such as controlling which functions of the application or process are able to run. By contrast, in the network layer of the OSI model, a fine-grain control system may implement permission rules that control which components are able to run and how those components may be configured.

In some embodiments, the operation of providing the access error data to an artificial intelligence model that has been trained to generate permission rules for processes may include providing the access error data to a plurality of artificial intelligence models that have been trained to generate permission rules for processes. Accordingly, the operation of receiving an update of the permission rules from the artificial intelligence model may include receiving an updated permission rule from each of the plurality of artificial intelligence models. Furthermore, for each of the plurality of artificial intelligence models, the updated permission rule received from the artificial intelligence model is provided to the fine-grain control system running in the computing system. The plurality of artificial intelligence models may have specialized training to generate permission rules for particular access errors or particular threats, the plurality of artificial intelligence models may be used to share the workload, the plurality of artificial intelligence models may be run on separate system management servers distributed throughout the computing system, or the plurality of artificial intelligence models may be each generate permission rules that are compared against each other to gain confidence or consensus as to an appropriate permission rule responsive to a given access error or threat.

In some embodiments, the artificial intelligence model may be trained with training data that includes threat data, software code and software build scripts, security specifications and configurations, and/or information describing the software architecture of the process or processes. In addition, the training data could further include information describing standard behavior of the process or processes or other resources, software installation scripts, and an installed configuration of software applications. Optionally, the training data may include paired input data matching an access error and/or a threat with a revised access rule that is known to mitigate the access error or the threat. Furthermore, the training data may be used to fine-tune a pre-trained artificial intelligence model, such as using the training data to update the weights of a general purpose language model (LM), such as a large language model (LLM), so that the LM is capable of enhanced performance of the specific task of generating permission rules for a fine-grain control system responsive to access errors and/or threats. Without limitation, the general purpose LM may be OpenAI's GPT-4, Google Gemini, BERT, or Meta's Llama 2.

In some embodiments, some or all of the training data may be obtained from existing sources. For example, the training data for the artificial intelligence model may include: (1) threat analysis, perhaps from open source industry standards and threat intelligence; (2) software code and software build scripts, perhaps from internal company data; (3) security specifications and configurations, perhaps from internal company security requirements; (4) information describing the software architecture, perhaps from internal software development team information; (5) information on standard process behavior, perhaps from open source industry standards and best practices; (6) installation scripts, perhaps from internal company specific scripts; and/or (7) an installed configuration, perhaps from internal company specific configurations. Without limitation, the training data may include threat data available from publicly disclosed breach documentation and annual threat reports such as that found in Verizon's 2024 Data Breach Investigations Report (https://www.verizon.com/business/resources/reports/dbir/).

In some embodiments, the artificial intelligence model may be trained during one or more stages of the development of a computing system. For example, the artificial intelligence model may receive data from monitoring proper or necessary computing system behaviors or accesses during the build, testing, and deployment stages of the computing system and generate the appropriate permission rules for one or more fine-grain control systems within the computing system to expressly permit those proper or necessary behaviors or accesses. For each stage of development, the artificial intelligence model may be trained to recognize existing access errors and/or attack types and configure the permission rules for one or more of the fine-grain control systems to prevent access errors and/or mitigate risks associated with those attack types. The artificial intelligence model may be dynamically fine-tuned using additional input data received during operation of the computing system, such as new access errors, attack information and/or changes to the server configuration and deployments within the computing system. For example, one or more of the fine-grain control systems could implement a permission rule that will restrict system incoming calls from a service, a specific IP address or a specific user attempting to execute a specific command on a specific file.

Some embodiments provide a method comprising various operations. The operations comprise monitoring performance of a process running on a compute node of a computing system and providing a plurality of permission rules to be implemented by a fine-grain control system running on the compute node, wherein, for each of the permission rules, the permission rule instructs the fine-grain control system to permit or deny the process with access to one or more resources identified by the permission rule. The operations further comprise receiving access error data from the compute node that identifies an access error experienced by the process, wherein the access error indicates that the process attempted to access a specific resource and was denied access to the specific resource by the fine-grain control system. Still further, the operations comprise providing the access error data to an artificial intelligence model that has been trained to generate permission rules for processes and receiving an update of the permission rules from the artificial intelligence model, wherein the update of the permission rules permits the process to access the specific resource indicated by the access error. In addition, the operations further comprise providing the update of the permission rules to the fine-grain control system running in the computing system.

Optionally, some embodiments of the method may include any one or more of the operations described herein in reference to computer program products. Still further, some embodiments may be directed to a system including the system management application in communication with the compute nodes of the computing system, wherein the system management application causes a processor to perform the operations indicated by the program instructions of the computer program product.

It is a technical benefit of some embodiments described herein that the AI model may generate permission rules for multiple instances of fine-grain control systems and multiple types of fine-grain control systems in a comprehensive manner. Not only can the AI model provide permission rules for use in multiple layers of the OSI model in a more complete and complimentary fashion, but the AI model may also provide permission rules for different types of fine-grain control systems. For example, one type of fine-grain control system may be implemented on a web application firewall and another type of fine-grain control system may be implemented on a network firewall. depending upon the fine-grain control system may

As used herein, a “correlated” fine-grain control policy may be implemented so that that the permission rules that work in one context for one fine-grain control system are consistent with the permission rules that work in another context for another fine-grain control system. For example, the context of a first application that is written primarily in Java and is hosted in a public cloud computing environment will differ greatly from the context of a second application that is written in Python and is hosted by an on premise server. Embodiments provide a tool or system, including the system management security module, the AI model and the fine-grain control systems themselves, that works with, and assumes inputs from, other tools and policies that are available and relevant in any given context.

Embodiments may use a hierarchical (i.e., a logical order for implementing the permission rules, perhaps a tree-like structure), correlated, self-tuning fine-grain permission AI model. For example, the permission rules may be evaluated and implemented in a logical tree-like structure from the bottom layer of the OSI model to the top layer of the OSI model, namely (1) physical layer, (2) data link layer, (3) network layer, (4) transport layer, (5) session layer, (6) presentation layer and (7) application layer.

One non-limiting example of a threat is a vulnerability found in Log4j, which is an open-source logging library commonly used by apps and services across the Internet. A Log4j attack uses standard web interfaces and is based on the attacker executing remote execution from the logging component of the system to potentially break into systems, steal passwords and logins, extract data, and infect networks with malicious software. However, a known fix is available. Accordingly, the AI model may create permission rules for the fine-grain control system that will specify that the web application logger Log4j can only write to the logs and nothing else. In another example, embodiments may generate permission rules for SELinux, Java Security Manager, and/or IPTables configurations after installation has been completed.

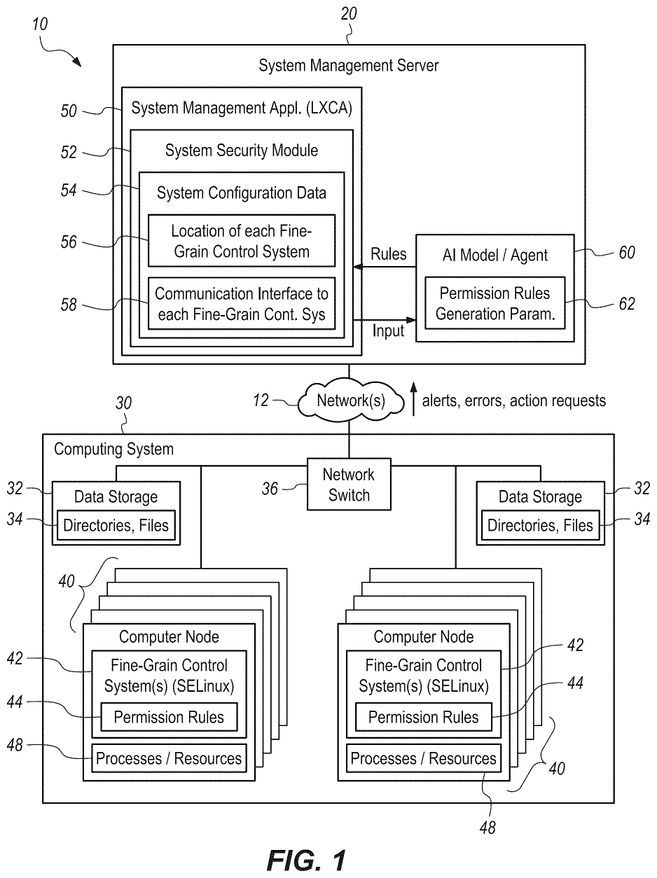

FIG. 1 is a diagram of a system 10 implementing fine-grain control for processes 48 running on compute nodes 40 within the computing system 30 or other available resources 48. The computing system 30 includes a plurality of compute nodes 40 that run at least one fine-grain control system 42, such as SELinux. The fine-grain control systems 42 implement a set of permission rules (access control rules) 44. Any number of processes 48 may be run on each compute node 40 and any number of resources may be available on each compute node, wherein the permission rules 44 cause the fine-grain control system 42 to limit the resources that a process 48 may access and/or other processes, entities or resources that may access the process 48. For example, one of the processes 48 may be permitted to access certain directories or files 34 stored on a data storage device 32, whereas other processes or resources 48 may be prevented from accessing those same directories or files 34. Accordingly, the fine-grain control systems 42 use the permission rules 44 to provide each process or resource 48 with access to certain resources permitted by the permission rules 44 so that the process may function properly and efficiently but limit each process 48 from having access to other resources that the process does not need. Similar permission rules may be implemented to control which other processes or resources may access a particular process or resource. Furthermore, the permission rules may include permissive rules, restrictive rules or some combination of permissive and restrictive rules.

The system 10 further includes a system management server 20 running a system management application 50, such a Lenovo XClarity Administrator (LXCA). The system management application 50 may include various modules and services to monitor, control, maintain and update software and hardware components of the computing system 30. Accordingly, the system management application 50 may communicate with, for example, the compute nodes 40 over one or more networks 12, one or more switches 36, and/or other networking components. In various embodiments, the components of the compute nodes 40 may report alerts, errors, and action requests to the system management application 50 and the system management application 50 may provide instructions to the components of the compute nodes 40.

The system management application 50 may include a wide variety of module for performing various functions, such as a system security module 52 for managing the security of the computing system 30 and the components within the computing system 30. In accordance with various embodiments, the system security module 52 may perform system security operations and may store or access system configuration data 54 including location data 56 that identifies the location of each fine-grain control system 42. Furthermore, the system configuration data 54 may include one or more communication interface 58 enabling communication with each of the fine-grain control systems 42. Specifically, the system security module 52 of the system management application 50 may use the location data 56 and the communication interface(s) 58 to communicate with the fine-grain control systems 42 on each of the compute nodes 40 in the computing system 30. This communication may include the provision of original and updated permission rules 44 from the system security module 52 to the fine-grain control systems 42.

During the building, testing, and deployment stages of the computing system 30, the system security module 52 may obtain information about the hardware and software configuration of the computing system 30. The system security module 52 may provide this configuration data along with knowledge of the fine-grain control systems 42 and possible knowledge about the processes 48 to the artificial intelligence (AI) model or agent 60. The AI model 60 may be prompted to use its permission rule generation parameters 62 to generate appropriate permission rules 44 for the one or more fine-grain control systems 42 within the computing system 30 to permit each process to perform necessary behaviors, such as access necessary resources, while restricting access to unnecessary resource. An initial set or sets of permission rules output by the AI model 60 are provided to the system security module 52 and the system security module 52 then sends the set or sets of the permission rules 44 to the various fine-grain control systems 42.

In some embodiments, the artificial intelligence model may be trained at one or more stages of development to recognize existing access errors and/or attack types and configure the permission rules for one or more of the fine-grain control systems to prevent such access errors and/or mitigate risks associated with those attack types. Furthermore, during ongoing use of the computing system 30, any alerts, access error data, threat or attack data, changes in the compute node configurations and/or action requests that are generated by the compute nodes 40 are reported to the system management application 50, such as the system security module 52, and shared with the AI model 60. The AI model may use this input data gathered during operation of the computing system to dynamically fine-tune the parameters of the AI model and also to generate one or more updates to the permission rules. Those updates are provided to the system security module 52 and the system security module 52 then sends the updated permission rules to the various fine-grain control systems 42. It should be appreciated that this provides the technical benefit of updating the permission rules in real-time to reduce any interruption of process performance and to respond quickly to deter attacks on the security of the computing system. Accordingly, a fine-grain control system may be implemented to gain the benefits of a highly secure computing system without sacrificing performance or causing undue burden on system administrative personnel.

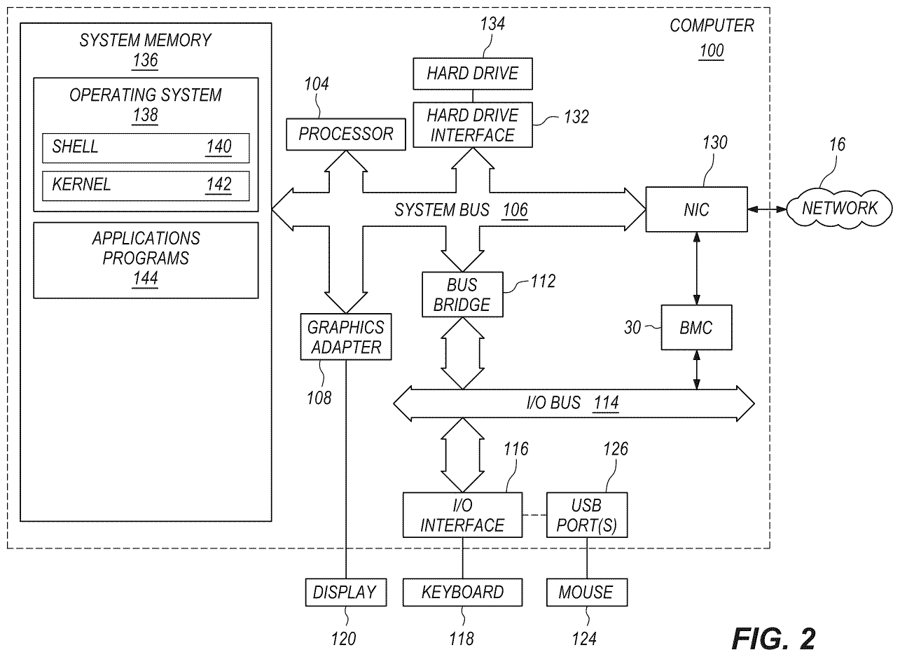

FIG. 2 is a diagram of one embodiment of a computer 100 that may be representative, but not limiting, of the configuration of the system management server 20, the compute nodes 40 and/or an optional remote server/service providing the AI Model/Agent 60 of FIG. 1. The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, such as a keyboard 118 (perhaps as a touch screen virtual keyboard), and a USB mouse 124 via USB port(s) 126 (or other type of pointing device, such as a trackpad). The I/O bus 114 may also provide communication to the BMC 30. As depicted, the computer 100 may communicate with other devices over the network 16 using a network adapter or network interface controller (NIC) 130. The hardware elements depicted in the computer 100 are not intended to be exhaustive, but rather are representative. For instance, the computer 100 may include non-volatile memory and the like.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as the lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management. As shown, the computer 100 includes application programs 144 in the system memory of the computer 100. Where the computer 100 is representative of a system management server 20 (see FIG. 1), the application programs 144 may include the system management application 50 and the AI model 60. Where the computer 100 is representative of a compute node 40 (see FIG. 1), the application programs 144 may include various processes running on the computer 100, and the operating system 138 or application programs 144 may include one or more fine-grain control systems 42. For embodiments where the AI model is run on a separate compute nod, the application programs 144 may include the AI model 60 (see FIG. 1). However, it should be understood that the system management application 50, the AI model 60, and/or the processes 48 and fine-grain control systems 42 may be run in a cloud computing environment.

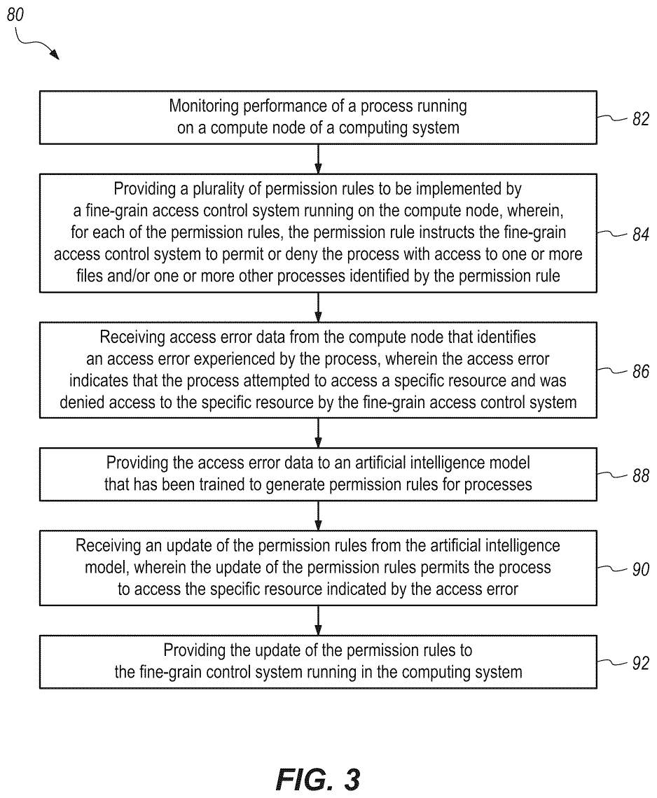

FIG. 3 is a flowchart of operations 80 performed by a system management application according to one embodiment. Operation 82 includes monitoring performance of a process running on a compute node of a computing system. Operation 84 includes providing a plurality of permission rules to be implemented by a fine-grain control system running on the compute node, wherein, for each of the permission rules, the permission rule instructs the fine-grain control system to permit or deny the process with access to one or more files and/or one or more other processes identified by the permission rule. Operation 86 includes receiving access error data from the compute node that identifies an access error experienced by the process, wherein the access error indicates that the process attempted to access a specific resource and was denied access to the specific resource by the fine-grain control system. Operation 88 includes providing the access error data to an artificial intelligence model that has been trained to generate permission rules for processes. Operation 90 includes receiving an update of the permission rules from the artificial intelligence model, wherein the update of the permission rules permits the process to access the specific resource indicated by the access error. Operation 92 includes providing the update of the permission rules to the fine-grain control system running in the computing system.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable storage medium and program instructions embodied therein, the program instructions being configured to be executable by a processor to cause the processor to perform operations comprising:
monitoring performance of a process running on a compute node of a computing system;
providing a plurality of permission rules to be implemented by a fine-grain control system running on the compute node, wherein, for each of the permission rules, the permission rule instructs the fine-grain control system to permit or deny the process with access to one or more files and/or one or more other processes identified by the permission rule;
receiving access error data from the compute node that identifies an access error experienced by the process, wherein the access error indicates that the process attempted to access a specific resource and was denied access to the specific resource by the fine-grain control system;
providing the access error data to an artificial intelligence model that has been trained to generate permission rules for processes;
receiving an update of the permission rules from the artificial intelligence model, wherein the update of the permission rules permits the process to access the specific resource indicated by the access error; and
providing the update of the permission rules to the fine-grain control system running in the computing system.

2. The computer program product of claim 1, wherein the resource is selected from a file, folder, process and/or logical port.

3. The computer program product of claim 1, wherein the update of the permission rules includes a revision to one or more of the permission rules and/or an additional permission rule.

4. The computer program product of claim 1, wherein the access error data is included in an output log.

5. The computer program product of claim 1, wherein the permission rules include a restrictive rule that prevents the process from accessing one or more specific resources that are expressly identified.

6. The computer program product of claim 1, wherein the permission rules include a permissive rule that allows the process to access only one or more specific resources that are expressly identified.

7. The computer program product of claim 1, wherein the artificial intelligence model generates the update of the permission rules during operation of the process on the computing system running the fine-grain control system.

8. The computer program product of claim 1, wherein the artificial intelligence model is a language model.

9. The computer program product of claim 1, wherein the operations of receiving access error data from the compute node, providing the access error data to the artificial intelligence model, receiving an update of the permission rules from the artificial intelligence model, and providing the update of the permission rules to the fine-grain control system running in the computing system are repeated continuously, periodically, and/or in response to some event.

10. The computer program product of claim 1, further comprising:
receiving real-time threat data from the compute node that identifies a threat posed against the process by another process accessing the process or one of the resources to which the process has access;
providing the real-time threat data to the artificial intelligence model;
receiving a second update of the permission rules from the artificial intelligence model, wherein the second update of the permission rules prevents the threat posed against the process indicated by the threat data; and
providing the second update of the permission rules to the fine-grain control system running in the computing system.

11. The computer program product of claim 1, wherein the computing system runs a plurality of fine-grain control systems, wherein the operation of providing a plurality of permission rules to be implemented by a fine-grain control system running on the compute node includes providing a plurality of permission rules to be implemented by each of the fine-grain control systems, and wherein the operation of providing the update of the permission rules to the fine-grain control system running in the computing system includes providing the update of the permission rules to the fine-grain control system running on the compute node where the process that experienced the access error is also running.

12. The computer program product of claim 11, wherein the plurality of fine-grain control systems running in the computing system include at least one fine-grain control system running on each of a plurality of compute nodes within the computing system.

13. The computer program product of claim 11, wherein the plurality of fine-grain control systems running in the computing system include at least one fine-grain control system running on each of a plurality of layers of a software stack running on at least one compute node within the computing system.

14. The computer program product of claim 1, wherein the operation of providing the access error data to an artificial intelligence model that has been trained to generate permission rules for processes includes providing the access error data to a plurality of artificial intelligence models that have been trained to generate permission rules for processes, wherein the operation of receiving an update of the permission rules from the artificial intelligence model includes receiving an updated permission rule from each of the plurality of artificial intelligence models, and wherein, for each of the plurality of artificial intelligence models, the updated permission rule received from the artificial intelligence model is provided to the fine-grain control system running in the computing system.

15. The computer program product of claim 1, further comprising:
training the artificial intelligence model with training data that includes threat data, software code and software build scripts, security specifications and configurations, and/or information describing the software architecture of the process.

16. The computer program product of claim 15, wherein the training data further includes information describing standard behavior of the process, software installation scripts, and/or an installed configuration of software applications.

17. The computer program product of claim 1, further comprising:
training the artificial intelligence model with training data that includes paired input data matching an access error and/or a threat with a revised access rule that is known to mitigate the access error or the threat.

18. The computer program product of claim 1, further comprising:
identifying necessary computing system behaviors during the build, testing, and deployment of the computing system; and
generating the permission rules for the specific fine-grain control system to permit the necessary computing system behaviors.

19. The computer program product of claim 1, further comprising:
causing the artificial intelligence model to be dynamically fine-tuned with the access error data and/or threat data.

20. The computer program product of claim 1, wherein one or more of the permission rules restricts system calls from a service, a specific IP address and/or a specific user from executing a specific command on a specific file.
